(19) United States
(12) Patent Application Publication
(10) Pub. No.: US 2007/0124666 A1
(43) Pub. Date: May 31, 2007

(54) Custom loading activity or progress animation

(75) Inventors: Aaron J. Sauve, Seattle, WA (US); Brian E. Manthos, Sammamish, WA (US); Bruce A. Morgan, Bellevue, WA (US); Dean J. Hachamovitch, Clyde Hill, WA (US); Tony Schreiner, Redmond, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/289,774

(22) Filed: Nov. 29, 2005

(51) Int. Cl. G06F 15/00

(52) U.S. Cl. 715/513

(57) ABSTRACT

Custom loading activity or progress animation is provided in which an activity indicator file, specific to a particular web site or page, is downloaded on a user's computing device. When a user browses to that particular web site or page, the user's browser retrieves the site-specific animation and renders it for the user.

### BACKGROUND

Today, when an application, such as a web browser, loads a web page, it typically uses some type of generic animation that is displayed for the user to inform the user of the loading activities. For example, a small animated icon might appear in the browser to ensure that the user is aware the page is still loading. This generic animation is typically used for each and every web page that is loading.

### SUMMARY

Custom loading activity or progress animation is provided in which an activity indicator file, specific to a particular web site or page, is downloaded on a user's computing device. When a user browses to that particular web site or page, the site-specific animation can be retrieved and rendered for the user while the associated page is loading.

### BRIEF DESCRIPTION OF THE DRAWINGS

FIG. 1 illustrates a system in which the inventive embodiments can be employed in accordance with one embodiment.

FIG. 2 illustrates a web page in accordance with one embodiment.

FIG. 3 is a flow diagram that describes steps in a method for creating a custom activity indicator file in accordance with one embodiment.

FIG. 4 is a flow diagram that describes steps in a method that a browser can implement when deciding whether to load a custom activity indicator file in accordance with one embodiment.

### DETAILED DESCRIPTION

Overview

Custom loading activity or progress animation is provided in which an activity indicator file, specific to a particular web site or page, is downloaded on a user's computing device. When a user browses to that particular web site or page, the site-specific animation is retrieved by, for example, a web browser and rendered for the user while the associated page is loading. The custom animation, which in the context of this document includes site-specific and/or page specific animation, can be displayed in any suitable location of a particular page. For example, the animation can be displayed near an address bar where a user may type a particular URL. Alternately or additionally, the animation can be displayed in other areas. For example, some browsers are designed to permit browsing with a feature known as tabbed browsing. In these types of browsers, the animation can be displayed within a particular tab.

In this manner, site owners can customize the loading animation and provide a degree of branding for their site. In addition, customized loading animation can add excitement to the user experience by adding an extra degree of “splash” to a web site.

Exemplary System

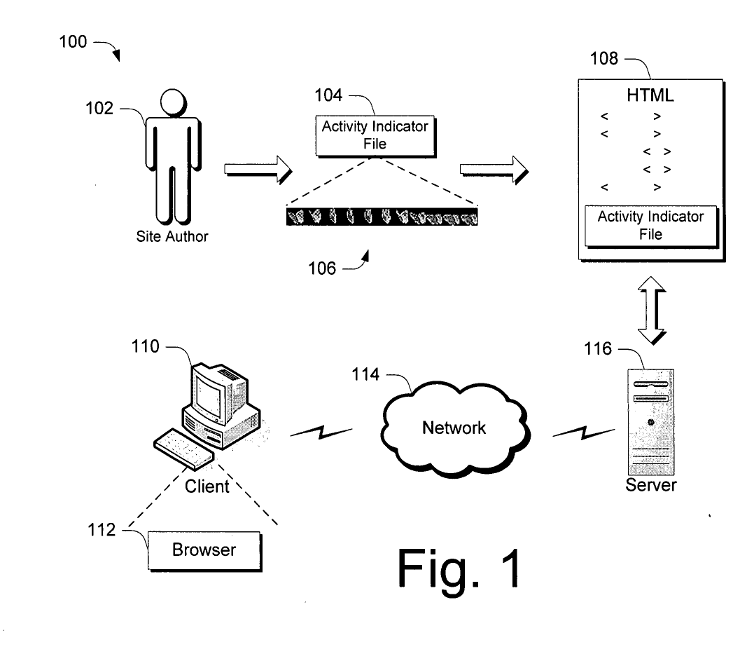

FIG. 1 illustrates, generally at 100, an exemplary system in which the inventive principles can be implemented in accordance with one embodiment. In system 100, a site author 102 can, through any suitable techniques, create a custom activity indicator file 104. Typically, the activity indicator file is created through some type of design or animation software. The custom animation activity indicator file can comprise any suitable type of file that might be created. In but one embodiment, the activity indicator file comprises a bitmap, such as the one shown generally at 106. The activity indicator file can comprise one that is utilized to provide moving animation or one that provides a static image. Other techniques and approaches can be used to create the activity indicator file. For example, other image formats can be used to store multiple sub-images that are utilized in the animation and include, by way of example and not limitation, animated GIF, animated cursor files, ANI, MPNG and the like.

In this example, however, bitmap 106 resides in the form of a strip with a number of images shown in different states. In this particular example, the bitmap strip illustrates a butterfly flapping its wings. In at least some embodiments, the custom activity indicator file can be used as a marketing tool to brand or otherwise identify itself with the owner of the web site. In this manner, the custom activity indicator file can provide top level branding during page loading activities.

After the activity indicator file is created, it can be incorporated into the HTML code 108 that defines a web page. The load file can either comprise part of the HTML itself, or a reference in the HTML can point to a location where the custom activity indicator file can be retrieved.

System 100 also includes at least one client device 110. Client 110 can comprise any suitable computing device, such as a general purpose computer, handheld computer and the like. Client 110 executes software applications, one of which is illustrated at 112 in the form of a web browser. System 100 also includes a network 114 via which client 110 can communicate with a server 116. In this example, network 114 comprises the Internet, although other networks can be utilized without departing from the spirit and scope of the claimed subject matter.

When a user navigates, via browser 112, to a particular web site for the first time, the browser looks to see if there is a custom activity indicator file associated with the web site. In this particular example, it does so by examining the HTML associated with a particular page looking for a reference to an activity indicator file (e.g. a “activity_indicator.bmp” file set off by the appropriate HTML tags).

If the web browser finds that there is an associated activity indicator file, the activity indicator file is retrieved and can then, in at least some embodiments, be pre-processed to ensure that it is in the correct form for display. One example of how this can be done is provided below under the heading “Pre-processing the Activity Indicator File”.

Having found the activity indicator file, the web browser then caches the activity indicator file and renders the animation while the associated page is loading. The activity indicator file can be rendered in any suitable manner. In those embodiments in which the activity indicator file resides in the form of a bitmap strip, the file can be rendered by displaying the individual images of the strip and using a timer to cycle between the images in succession.

As noted above, the activity indicator file can be rendered in any suitable location of the web page that is loading. For example, the animation can be rendered adjacent the page's address bar responsive to a user typing in a URL. Alternately or additionally, the animation can be rendered in conjunction with tabs that can be presented by the browser in a tabbed browsing environment which is described in more detail just below.

Tabbed Browsing

As noted above, in at least some embodiments, the inventive principles are implemented in the context of a tabbed browsing environment. Tabbed browsing refers to the ability to organize and manage groups of web pages using so-called “tabs” that are displayed as part of the browser's user interface. Using tabbed browsing, web pages are loaded in tabs within the same browser window, thus making it easier to switch back and forth among multiple web pages.

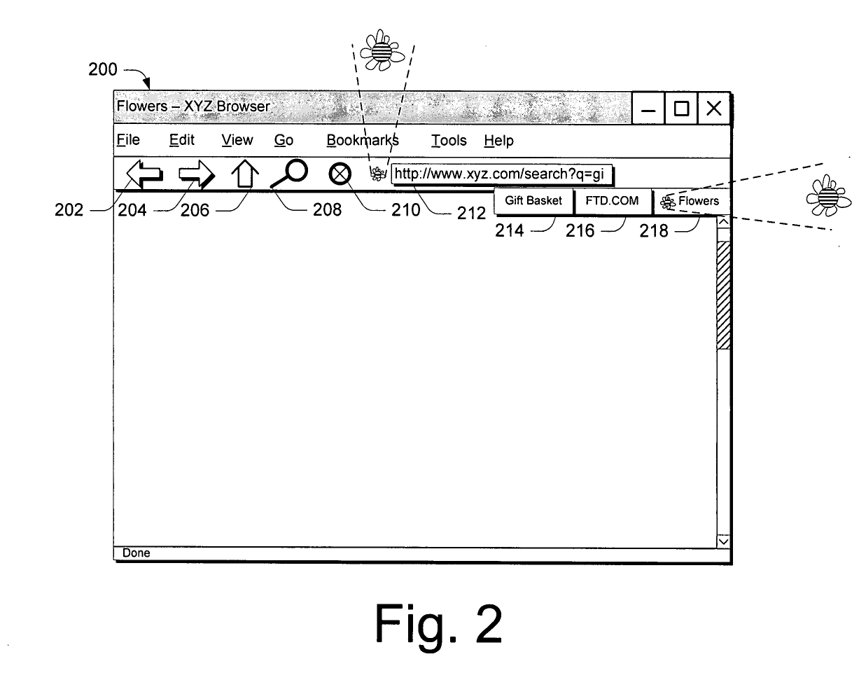

As an example, consider FIG. 2 which illustrates an exemplary browser window 200. There, window 200 includes a number of typical user interface elements such as back and forward navigation elements 202, 204 respectively, a home element 206, a search element 208 and a stop element 210. In addition, an address bar 212 is provided in which a user can type an associated web address to have the browser window navigated to that address.

In addition, just below the address bar appear three tabs 214, 216 and 218. Each of these individual tabs is associated with an individual web page. Accordingly, by clicking on a particular tab, focus of the browser window is shifted to that web page which, in turn, changes some of the state information associated with the browser window. For example, when the user clicks on tab 214, the web page associated with that tab is brought into focus and the navigation instrumentalities (e.g. back and forward elements 202, 204) are now associated with navigation activities that occur relative to that web page. The same thing occurs when the user clicks on tabs 216 and 218.

Accordingly, tabs provide the ability to display visible indicia to a user that represents the web page with which the tab is associated, as well as the ability for the user to select and quickly navigate the web pages.

In this particular example, notice that tab 218 is associated with a “Flowers” site and that a activity indicator file in the form of a flower is being rendered for the user within the associated tab while the associated page loads. The animation art is shown in an enlarged view just to the right of the browser window. Notice also that the activity indicator file is shown as being rendered adjacent address bar 212. The illustration is provided simply to show that it is possible to render the activity indicator file at multiple locations within the browser window. For example, in the event multiple tabs are opened and loading individual pages, different activity indicator files associated with those individual pages can be rendered contemporaneously.

Exemplary Methods

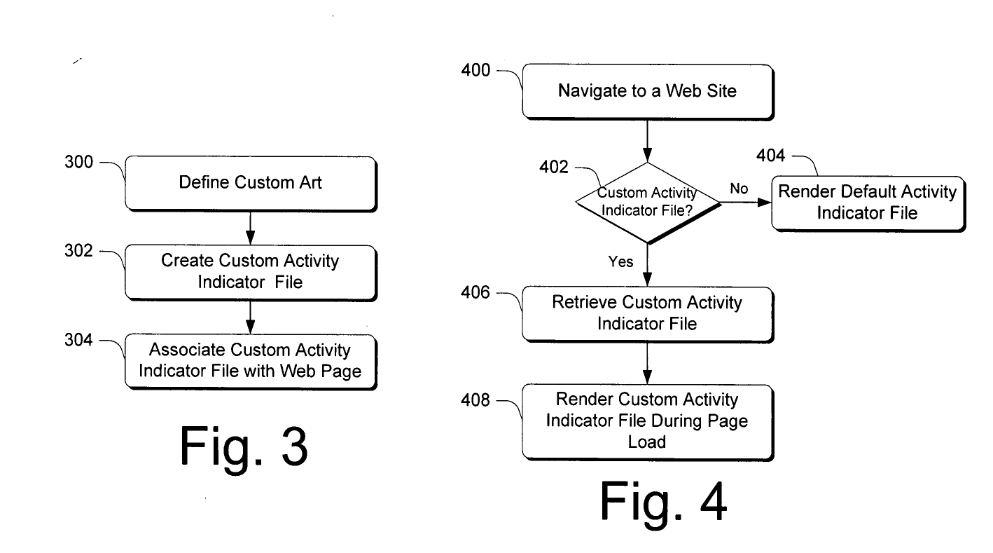

FIG. 3 is a flow diagram that describes steps in a method for creating a custom activity indicator file in accordance with one embodiment. The method can be implemented in connection with any suitable hardware, software, firmware or combination thereof. In one embodiment, the method is implemented, at least in part, in software in the form of an application that executes on a computing device.

Step 300 defines custom art. This step can be performed in any suitable way. In at least some embodiments, this step can be performed using software that permits the animation to be designed. Examples of such software include computer-aided design software. This step can be performed by any suitable entity such as a site owner, web page designer and the like. Step 302 creates a custom activity indicator file. This can be done by packaging the custom art created at step 300 in a suitable format for provision over a network such as the Internet.

Step 304 associates the custom activity indicator file with a web page. This step can be performed in any suitable way. For example, in at least some embodiments, the association of the custom activity indicator file with the web page can take place via an association that is created in the HTML for the page. It is to be appreciated and understood that this step can be performed in a manner that associates different activity indicator files with different pages within a particular domain. Alternately or additionally, this step can be performed by associating one activity indicator file with all pages of a particular domain.

FIG. 4 is a flow diagram that describes steps in a method for rendering a custom activity indicator file in accordance with one embodiment. The method can be implemented in connection with any suitable hardware, software, firmware or combination thereof. In one embodiment, the method is implemented, at least in part, in software in the form of a web browser that executes on a computing device, such as the one shown in FIG. 1.

Step 400 navigates to a web site. The step can be performed responsive to a user clicking on a link, entering an URL in an address bar, or through any other activity that can cause a browser to navigate to a site. Step 402 determines whether the site or page has an associated custom activity indicator file. This step can be performed in any suitable way. For example, in at least some embodiments this step can be performed by examining the HTML that comprises part of the page that is being browsed.

If there is not a custom activity indicator file, then step 404 renders, if available, any default activity indicator file during page load. This step can be performed by accessing the appropriate location on the client computer's and retrieving the default activity indicator file if present. If, on the other hand, step 402 ascertains that there is a custom activity indicator file associated with a particular page, then step 406 retrieves the custom activity indicator file.

This step can be performed in a couple of different ways. For example, if this is the first time that the user has browsed to the page, then the activity indicator file is typically retrieved from a remote location, such as a server, and cached on the user's computer. As part of this process, the custom activity indicator file can be preprocessed as described below. If, on the other hand, the user has browsed to this site before and the custom activity indicator file has been previously retrieved, this step can be performed by locating the file on the user's computer.

Once the custom activity indicator file has been retrieved from whatever location, step 408 renders the custom file during the page's loading.

Pre-Processing the Activity Indicator File

As noted above, the custom activity indicator file can be pre-processed to ensure that it is in the proper format for rendering. As but one example of how this can be done, consider the following.

In some embodiments, the space in which the custom activity indicator file is to be rendered is constrained. For example, FIG. 2's tabbed browsing environment finds the custom activity indicator file being rendered in a small area of an associated tab. Hence, it can be advantageous to ensure that the activity indicator file can be rendered in this area in a visually accurate manner. As such, if necessary, and in those embodiments in which a bitmap strip is utilized, the bitmap strip can be divided up and scaled appropriately.

As an example, consider the following. Assume that the rendering area on a web page is 16×16 pixels. In this case, the width of the bitmap strip can be integer divided by the height of the strip to produce the number of strip frames. Individual frames can then be extracted and scaled to the 16×16 dimension and later passed to the appropriate components for rendering. After pre-processing, the pre-processed strip can then be cached on the user's computer for future use.

### CONCLUSION

Custom loading activity or progress animation is provided in which a activity indicator file, specific to a particular web site or page, is downloaded on a user's computing device. When a user browses to that particular web site or page, the site-specific animation is retrieved and rendered for the user. In this manner, site owners can customize the loading animation and provide a degree of branding for their site. In addition, customized loading animation can add excitement to the user experience by adding an extra degree of “splash” to a web site.

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

1. A computer-implemented method comprising:
creating a custom activity indicator file that includes custom art; and
associating the custom activity indicator file with a web page in a manner that permits the custom activity indicator file to be rendered while the web page is being loaded by a browser and which indicates to a user that the associated web page is currently loading.

2. The method of claim 1 further comprising making the custom activity indicator file available over a network.

3. The method of claim 1, wherein the act of associating is performed by creating an association in HTML that defines at least a portion of the web page.

4. The method of claim 1, wherein the act of creating and associating comprises creating and associating multiple different custom activity indicator files for different web pages within a particular domain.

5. The method of claim 1, wherein the act of creating comprises creating a bitmap strip containing animation art.

6. The method of claim I further comprising prior to the act of creating, defining the custom art.

7. A computer-implemented method comprising:
navigating to a web site;
determining whether the site has an associated custom activity indicator file;
in an event the site has an associated custom activity indicator file, retrieving the custom activity indicator file; and
rendering the custom activity indicator file while loading a page associated with the web site.

8. The method of claim 7, wherein the act of determining is performed by examining HTML that comprises part of a page of the web site.

9. The method of claim 7, wherein said acts are performed by a web browser.

10. The method of claim 7, wherein the act of retrieving comprises retrieving the custom activity indicator file from a remote location.

11. The method of claim 7, wherein the act of retrieving comprises locally retrieving the custom activity indicator file.

12. The method of claim 7, wherein the custom activity indicator file defines a bitmap strip that provides animation art.

13. The method of claim 7, wherein the act of rendering is performed by rendering the custom activity indicator file adjacent an address bar in a browsing window.

14. The method of claim 7 further comprising pre-processing the custom activity indicator file to ensure that animation defined by the file fits within an area in which it is to be rendered.

15. A computer-implemented method comprising:
providing a browser window defining a tabbed browsing environment that can present one or more tabs to a user;
using the browser window, navigating to a web site;
determining whether the site has an associated custom activity indicator file;
in an event the site has an associated custom activity indicator file, retrieving the custom activity indicator file; and
rendering the custom activity indicator file within a tab while loading a page associated with the web site.

16. The method of claim 15, wherein the act of determining is performed by examining HTML that comprises part of a page of the web site.

17. The method of claim 15 further comprising in an event the site does not have an associated custom activity indicator file, rendering a default animation file during page load.

18. The method of claim 15, wherein the act of retrieving comprises retrieving the custom activity indicator file from a remote location.

19. The method of claim 15, wherein the act of retrieving comprises locally retrieving the custom activity indicator file.

20. The method of claim 15, wherein the custom activity indicator file defines a bitmap strip that provides animation art.
